(19) United States
(12) Patent Application Publication
(10) Pub. No.: US 2021/0015128 A1
(43) Pub. Date: Jan. 21, 2021

(54) NOVEL PROCESS FOR PREPARING HABESHA DRIED FOOD PRODUCTS

(71) Applicant: Pharmaceutical Technology Solutions, Morris Plains, NJ (US)

(72) Inventors: Isaac Ghebre-Sellassie, Morris Plains, NJ (US); Amleset Teweldemedhin, Morris Plains, NJ (US)

(21) Appl. No.: 16/929,802

(22) Filed: Jul. 15, 2020

Related U.S. Application Data
(60) Provisional application No. 62/921,933, filed on Jul. 15, 2019.

(51) Int. Cl. A23L 3/44; A23L 23/10; A23L 11/00; A23L 31/00; A23L 13/10; A23L 17/10; A23L 19/00; A23L 27/14; A23L 27/10; A23L 27/40; A23L 5/00; A23L 7/10; A23L 5/10; A23L 3/36; A23P 10/40; A23L 3/3436; B65D 81/26

(52) U.S. Cl. CPC A23L 3/44; A23V 2002/00; A23L 11/05; A23L 31/00; A23L 13/10; A23L 17/10; A23L 19/01; A23L 27/14; A23L 27/105; A23L 27/40; A23L 5/55; A23L 7/198; A23L 5/10; A23L 3/36; A23P 10/40; A23L 3/3436; B65D 81/266; A23L 23/10

(57) ABSTRACT

Habesha dried food product is prepared according to the steps of: selecting ingredients from at least one of a major food group, an accessory food group, and a whole grain; cooking the selected ingredients according to a Habesha cuisine to result in a form of food; partially dehydrating and freeze drying the freshly prepared form of food to result in segmented dried form of food; or directly freeze drying the freshly prepared form of food to result in powdered dried form of food; and packaging the dried form of food in moisture resistant containers to result in packaged Habesha dried food product. Dried food thus prepared results in less digestive discomfort, shortened food preparation, reduced objectionable smell, and stable products requiring no refrigeration.

### CROSS-REFERENCE TO RELATED APPLICATION

This application claims the benefit of U.S. Provisional Patent Application No. 62/921,933, filed Jul. 15, 2019, the contents of which are herein fully incorporated by reference.

### FIELD OF THE INVENTION

The invention pertains to a drying and packaging process that overcomes the shortcomings of handling and storage of Habesha foods, and provides opportunities for these foods to remain fresh for an extended period of time and become widely available to many people across the world for convenient consumption.

### BACKGROUND OF THE INVENTION

Habesha or Eritrean/Ethiopian dishes are very popular with many communities in different parts of the world as witnessed by the number of people that frequently visit Eritrean and Ethiopian restaurants. The dishes typically consist of vegetables, legumes, mushroom, fish, meat, or combinations thereof in the form of a sauce or stew, all served on top of a round sourdough crepe (a flatbread known as Injera) made out of fermented whole grains such as teff, sorghum, millet, and corn. The flatbread is typically less than one centimeter in thickness and about fifty centimeters in diameter.

The dishes are traditionally cooked immediately before serving to ensure that they remain warm and fresh when they are consumed. This tradition has been practiced by Eritrean and Ethiopian expatriates throughout the world, whether the food is served in a home setting or at the many Eritrean and Ethiopian restaurants that have flourished throughout the world.

However, the traditional Habesha dishes, as popular as they are with Eritreans, Ethiopians and other communities, are not widely accessible to many people for the following reasons:

First, the dishes have a short shelf life. Although the dishes can be stored in a refrigerator for a limited period of time to keep them fresh, refrigeration by itself does not entirely solve the practical challenges associated with long term storage, shipping, and use. The challenges are particularly acute in many underdeveloped and developing countries where refrigeration is not an option due to the lack of available refrigeration at the homes of many families.

Second, traditional Habesha dishes have an adverse effect on the digestive system of many people, particularly those who have acid or gastroesophageal reflux disease, Helicobacter pylori infection and dyspepsia. The problem is manifested by frequent belching, burping, bloating and/or heartburn that people experience after eating the dishes. The experience makes many people uncomfortable to the point of them avoiding many traditional Habesha dishes.

Third, preparation of the dishes as practiced for generations involves a lengthy process, taking as long as one hour or more to prepare, and hence is not well-suited to the fast-paced lifestyle that many people lead in today's environment.

Fourth, preparation of the traditional dishes at home also present another challenge. During cooking, an objectionable smell vaporizes and spreads throughout a residence adhering to clothing, sofas, carpets, etc., unless cooking is carried out outside the house or in a detached kitchen, which many people are not fortunate enough to have.

It is apparent, therefore, that these shortcomings need to be eliminated or minimized for the dishes to be accessible to a wider population.

The object of the present invention is to describe a process for the preparation of dried food forms that overcome the limitations of traditional Habesha dishes.

### SUMMARY OF THE INVENTION

According to an embodiment of the invention, a process for preparing Habesha dried food products includes the following steps:

(a) selecting ingredients from at least one of a major food group, an accessory food group and a whole grain; and

(b) cooking the selected ingredients in the style according to a Habesha cuisine to result in a fresh form of food, which is one of a sauce, a stew and a meal;

(c) determining a final state as either a segmented dried form of food, or a powdered dried form of food.

If the final state in step (c) is the segmented dried form of food, the process of preparing Habesha dried food product further comprises the steps of:

(d) partially dehydrating the fresh form of food in step (b) on a tray to 20-30% of water by weight to result in a cake of food;

(e) cutting the cake of food to result in a segmented cake of food;

(f) freezing the segmented cake of food at −20° C. to result in a frozen segmented cake of food;

(g) freeze-drying the frozen segmented cake of food to result in the segmented dried form of food, and

(h) packaging the segmented dried form of food in a moister resistant bag, or in a glass jar containing an oxygen absorber to result in a Habesha dried food product.

If the final state in step (c) is the powdered dried form of food, the process of preparing Habesha dried food product further comprises the steps of:

(i) freeze-drying the fresh form of food in step (b) directly to result in the powdered dried form of food; and

(j) packaging the powdered dried form of food in a moister resistant bag, or in a glass jar containing an oxygen absorber to result in a Habesha dried food product.

According to the invention, the major food group is at least one member from the group consisting of a legume, a mushroom, a meat, and a fish.

Also, according to the invention, the accessory food group is at least one member of the group consisting of a vegetable, a cooking oil, a seasoning and flavoring.

In addition, according to the invention, the whole grain is at least one member of the group consisting of quinoa, teff, corn, sorghum, buckwheat, brown rice, barley, oats, millet, barley and white wheat.

According to another embodiment of the invention, a process of serving Habesha food includes steps of:

(a) adding sufficient water to the Habesha dried food forms prepared according to the process of claim 1 to result in a water-reconstituted food, and

(b) heating the water-reconstituted food to result in the form of food to be served, wherein the form of food is at least one of the sauce, the stew and the meal.

### BRIEF DESCRIPTION OF THE DRAWING

FIG. 1 is a flow chart of how segmented dried sauce, dried stew, and dried meal are prepared.

FIG. 2 is a flow chart of how powdered dried sauce, dried stew, and dried meal are prepared.

### DETAILED DESCRIPTION OF THE INVENTION

### Definitions

Dish: A specific food preparation that is eaten with tableware or eaten out of hand.

Stew: A food preparation that is a thick soup consumed as is or served with other foods.

Sauce: A food preparation that is a thick liquid served with other foods

Meal: A food preparation that is a solid or hydrated semisolid food consumed as is

Seasonings: A food additive that intensifies the natural flavor of the food

Flavorings: A food additive that modifies the original flavor of the food.

Dehydration: A drying process that utilizes heat energy to drive off water.

### THE INVENTION

The invention pertains to a process for preparing dried Habesha food products that overcome the limitations of the traditional Habesha dishes. The process includes the steps of:

(a) selecting ingredients from at least one of a major food group, an accessory food group, and a whole grain;

(b) cooking the selected ingredients in the style according to a Habesha cuisine to result in a fresh form of food, which is one of a sauce, a stew and a meal; and

(c) determining a final state as either a segmented dried form of food, or a powdered dried form of food.

If the final state in step (c) is the segmented dried form of food, the process of preparing Habesha dried food product further comprises the steps of:

(d) partially dehydrating the fresh form of food in step (b) on a tray to 20-30% of water by weight to result in a cake of food;

(e) cutting the cake of food to result in a segmented cake of food;

(f) freezing the segmented cake of food at −20° C. to result in a frozen segmented cake of food;

(g) freeze-drying the frozen segmented cake of food to result in the segmented dried form of food; and

(h) packaging the segmented dried form of food in a moisture-resistant bag, or in a glass jar containing an oxygen absorber to result in the Habesha dried food product.

If the final state in step (c) is the powdered dried form of food, the process of preparing Habesha dried food product further comprises the steps of:

(i) freeze-drying the fresh form of food in step (b) directly to result in the powdered dried form of food; and

(j) packaging the powdered dried form of food in a moisture-resistant bags, or in a glass jar containing an oxygen absorber to result in the Habesha dried food product.

The major food group is at least one member from the group consisting of a legume, a mushroom, a meat, and a fish.

The accessory food group is at least one member of the group consisting of a vegetable, a cooking oil, and a seasoning and flavoring, and

The whole grain is at least one member of the group consisting of quinoa, teff, corn, sorghum, buckwheat, brown rice, barley, oats, millet, barley and white wheat.

The process according to the invention produce novel dried Habesha food forms that can complement or even replace traditional Habesha dishes.

Cooking

In one embodiment, selected food ingredients from the accessory food group only are mixed together and cooked in a pan placed on a stove at medium heat to produce a sauce. After the cooking step is completed, the pan is removed from the stove and the sauce is allowed to cool at room temperature.

In another embodiment, selected ingredients from the accessory food group are mixed and cooked in a pan placed on a stove at medium heat. Selected ingredients from the major food group are added, mixed and cooked to produce a stew. After the cooking step is completed, the pan is removed from the stove and the stew is allowed to cool at room temperature.

In yet another embodiment, selected ingredients from the accessory food group are mixed and cooked in a pan placed on a stove at medium heat. Selected ingredients from the major food group are added, mixed and cooked. Selected pre-cooked ingredients from whole grains are added and mixed towards the end of the cooking step to produce a meal. After the cooking step is completed, the pan is removed from the stove and the meal is allowed to cool at room temperature.

The amount of water in the freshly-prepared sauce, stew and meal range from about 20 to 50% by weight.

### Preparing Segmented Dried Form of Food

The cooled freshly prepared sauce, stew and meal are spread on trays and partially dehydrated at 65° C. until the water content is reduced to 20-30% by weight. This allows the heterogenous mixture in the food forms to form dense, continuous cakes that can be cut cleanly into segments using a sharp-edged cutter. If the freshly prepared food forms contain more than 30% water, it is impossible to cut the cakes into small segments with the desired dimensions since they cannot form a dense, continuous physical structure.

Similarly, if the water content is less than 15% by weight, it is difficult to cut the cake cleanly to the desired dimensions since the cake tends to fracture unevenly. The thickness of the cakes is kept below 1.0″ and, preferably, below 0.75″ to facilitate drying. Alternatively, the food forms can be transferred onto molds with the desired dimensions and partially dehydrated under the same conditions.

### Cutting

The cakes are cut manually while they are still on the trays using a sharp-edged cutter, although the cutting step can be automated during production. The desired dimensions range between 0.5″×2.0″×0.25″ and 4.0″×6.0″×0.75″, and preferably, between 1.0″×3.0″×0.5″ and 2.0″×3.0″×0.5″, although other dimensions can be selected if needed.

### Freezing

The segmented cakes on the trays are frozen in a freezer at −20° C. to reduce the freezing cycle time during the subsequent freeze-drying processes.

### Freeze-Drying

The frozen sauce, stew and meal are transferred to a freeze dryer and dried to less than 5% and, preferably less than 3%, of water by weight to result in segmented dried sauce, segmented dried stew and segmented dried meal.

### Preparing Powdered Form of Dried Food

The cooled freshly prepared sauce, stew and meal are spread on trays and freeze dried directly to result in powdered dried sauce, powdered dried stew and powdered dried meal.

Freeze drying is a low-temperature drying process that involves freezing the product at low temperatures followed by removal of the ice formed by sublimation. As the ice sublimes, it leaves behind voids within the food forms where the ice crystals were once present.

### Packaging

The dried sauce, stew and meal are finally packaged in moisture-resistant bags or glass jars containing oxygen absorbers.

### Unanticipated Beneficial Results

Surprisingly, the process according to the invention has led to the discovery of unanticipated beneficial results that cannot be duplicated by any other conventional drying methods.

During the freeze-drying process, it was discovered that an objectionable smell similar to that which vaporizes during the preparation of traditional Habesha dishes was detected in the water collected from defrosting the freeze dryer. Apparently, during the sublimation process, the water vapor strips the objectionable smell from the freshly prepared dishes and traps it in the ice as the vapor condenses on the sides of the chamber of the freeze dryer. As a result, the dried food forms prepared according to the invention do not contain the objectionable smell that vaporizes during the cooking of Habesha traditional dishes.

Freshly prepared traditional Habesha dishes contain concentrated amounts of seasonings, and watery and oily phases that easily separate, which appear to be the main reasons why many people, particularly those who have acid or gastroesophageal reflux disease, Helicobacter pylori infection and dyspepsia, cannot tolerate traditional Habesha dishes. In contrast, the dried food forms prepared according to the invention generate, after rehydration, more consistent texture of dishes that minimize ingredient separation and maximize uniform distribution of the seasonings throughout the dish, leading to a more palatable and integrated blend of ingredients. This consistency along with the removal of some of the ingredients that make up the objectionable smell during the freeze-drying step are believed to be the reasons why the dried food forms are well tolerated.

Preparing the Habesha dishes as they have been practiced for generations is very time-consuming, taking as long as one hour or more, and hence is not well-suited to the fast-paced lifestyle that many people lead in today's environment. In contrast, preparing dishes using the novel dried food forms according to the invention requires only less than five minutes.

The dried sauce, stew and meal food forms prepared by the process according to the invention do not need refrigeration and have a long shelf life due to the less than 5% moisture levels in the dried food forms.

### Forms of Food

According to an embodiment of the invention, when the form of food is the sauce, then the selecting ingredients from the accessory food group are 100% by weight.

According to an embodiment of the invention, when the form of food is the slew, then the selecting ingredients from the major food group and the accessory food group are in the following ratio by weight:

60-85% ingredients from the major food group, and

15-40% ingredients from the accessory food group.

According to an embodiment of the invention, when the form of food is the meal, then the selecting ingredients is from the major food group, the accessary food group, and the whole grain in the following ratio by weight:

30-55% ingredients from the major food group,

10-25% ingredients from the accessory food group, and

30-50% ingredients from the whole grain, wherein the whole grain is pre-cooked.

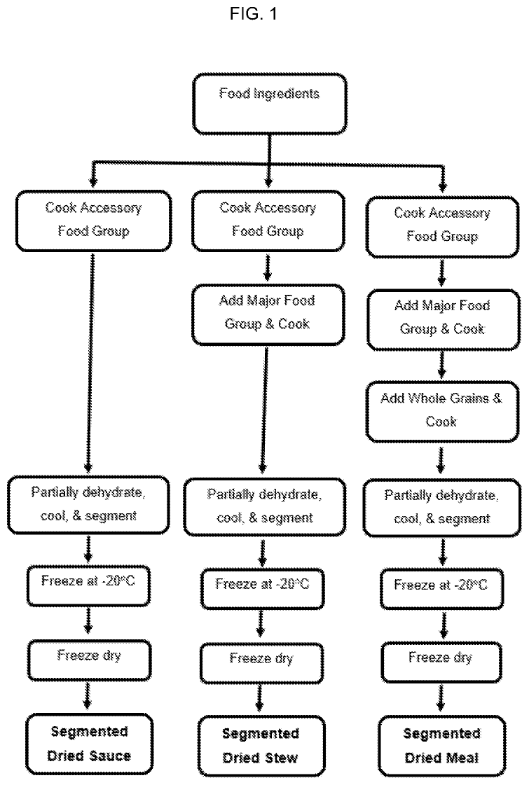

FIG. 1 is a summary of the process of preparing different forms of segmented dried food. According to FIG. 1, a segmented dried sauce is prepared by selecting food ingredients from the accessory food group only. Then the selected ingredients are cooked, partially dehydrated, cooled, cut into segments, frozen at −20° C., freeze-dried to result in the segmented dried sauce.

In addition, according to FIG. 1, a segmented dried stew is prepared by selecting food ingredients from the accessory food group first. Then the selected ingredients are cooked, and ingredients from the major food group are added and cooked with the accessary food group ingredients, partially dehydrated, cooled, cut into segments, frozen at −20° C., freeze-dried to result in the segmented dried stew.

Furthermore, according to FIG. 1, a segmented dried meal is prepared by selecting food ingredients from the accessory food group first. Then the selected ingredients are cooked, and ingredients from the major food group are added and cooked with the accessary food group ingredients. Finally, whole grain is added to this mixture and cooked, partially dehydrated, cooled, cut into segments, frozen at −20° C., freeze-dried to result in the segmented dried meal.

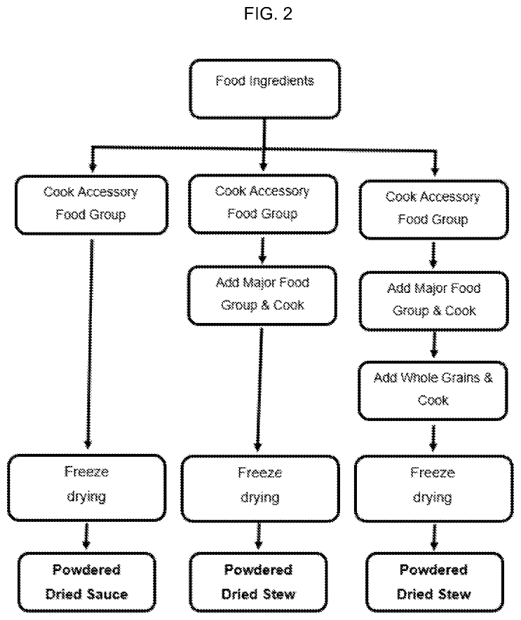

FIG. 2 is a summary of the process of preparing different forms of powdered dried food. According to FIG. 2, a powdered dried sauce is prepared by selecting food ingredients from the accessory food group only. Then the selected ingredients are cooked, and freeze-dried to result in the powdered dried sauce.

In addition, according to FIG. 2, a powdered dried stew is prepared by selecting food ingredients from the accessory food group first. Then the selected ingredients are cooked, and ingredients from the major food group are added and cooked with the accessary food group ingredients, and freeze-dried to result in the powdered dried stew.

Furthermore, according to FIG. 2, a powdered dried meal is prepared by selecting food ingredients from the accessory food group first. Then the selected ingredients are cooked, and ingredients from the major food group are added and cooked with the accessary food group ingredients. Finally, whole grain is added to this mixture and cooked, and freeze-dried to result in the powdered dried meal.

### Major Food Group

According to an embodiment of the invention, the legume is least one of lentils, beans, peas, and chickpeas.

According to an embodiment of the invention, the mushroom is least one of while button, portobello, cremini, maitake, button, hedgehog, morel and oyster.

According to an embodiment of the invention, the meat is least one of beef, lamb, chicken, goat, and pork.

According to an embodiment of the invention, the fish is least one of mackerel, tilapia, halibut, cod, trout, swordfish, salmon, and tuna.

### Accessory Food Group

According to an embodiment of the invention, the vegetable is least one of onion, kale, spinach, cabbage, tomatoes, avocados, eggplants, cucumbers, and bell peppers.

According to an embodiment of the invention, the cooking oil is at least one of olive oil, sunflower oil, soybean oil, safflower oil, corn oil, and canola oil.

According to an embodiment of the invention, the seasoning and flavoring is at least one of basil, bay leaf, celery seed, chives, garlic, cilantro, fennel, fenugreek, lemon grass, oregano, parsley, rosemary, sage, tarragon, thyme, mint, cardamom, cinnamon, coriander, allspice, cloves, nutmeg, paprika, pepper, turmeric, ginger, mace, saffron, vanilla, cumin, black seed, dill seed, wine, and salt.

### Whole Grains

According to an embodiment of the invention, the whole grain is at least one member of the group consisting of quinoa, teff, corn, sorghum, buckwheat, brown rice, barley, oats, millet, barley and white wheat.

Serving Habesha Food from Dried Food

According to an embodiment of the invention, a process of serving Habesha food is described. The steps of this process include:

(a) adding sufficient water to the Habesha dried food product prepared according to the process of claim 1, to result in a water-reconstituted food, and

(b) heating the water-reconstituted food to result in the form of food to be served, wherein the form of food at least one of the sauce, the stew and the meal.

### Rehydration

For serving, the dried sauce, dried stew and dried meal are rehydrated following procedures that are specific to each food form. Some may require initial soaking in cold water followed by hot water, while others may be added directly to hot water. To further improve the hydration process, sometimes the products may be allowed to simmer under low heat. The amount of water added and simmering time depend upon the type of dish and the desired texture. In all, it takes only less than five minutes to rehydrate the sauce or stew and make them ready for serving, compared to the more than an hour needed to make traditional Habesha dishes ready for serving.

### Advantages of Dried Food Forms

All ingredients in the novel died food forms are fresh raw materials that do not contain processed materials and preservatives. The novel food forms prepared according to the invention have many advantages over traditional Habesha dishes.

Reducing Digestive Discomfort

Traditional Habesha dishes appear to have an adverse effect on the digestive system of many people, particularly those who have acid or gastroesophageal reflux disease, Helicobacter pylori infection and dyspepsia. The problem is manifested by frequent belching, burping, bloating and/or heartburn that people experience after eating the dishes. The experience makes many people uncomfortable to the point of them avoiding many traditional fresh dishes. The reconstituted dried food forms in the invention eliminate or reduce the discomfort and allow people to enjoy the food products without any trouble.

### 2. Reducing Preparation and Serving Time

Preparing the Habesha dishes as they have been practiced for generations is very time-consuming, taking as long as one hour or more, and hence is not well-suited to the fast-paced lifestyle that many people lead in today's environment. In contrast, preparing the dishes using the novel dried food forms requires only less than five minutes.

### 3. Reduces Objectionable Smell

Preparation of the traditional Habesha dishes at home also poses another challenge. During cooking, an objectionable smell vaporizes and spreads throughout a residence adhering to clothing, sofas, carpets, etc., unless cooking is carried out outside the house or in a detached kitchen. In contrast, rehydration of the dried food forms prepared according to the invention does not generate an objectionable smell and hence can be carried out in any kitchen without any inconvenience.

### 4. Obviating the Need for Refrigeration

Unlike traditional Habesha dishes, the dried food forms prepared according to the invention do not need refrigeration during storage. They are packaged in moisture and oxygen resistant containers and have a long shelf-life. In addition, the dried food forms are light in weight due to the removal of 95 to 98% of the water during the drying process.

### EXAMPLES

The following examples are set forth so as to provide those of ordinary skill in the art with a complete disclosure and description of how to make and use the present invention. The examples are not intended to limit the scope of what the inventors regard as their invention, nor are they intended to represent that the recipes described below are all or the only recipes performed.

### Example 1: Segmented Dried Sauce

### Formulation

Accessory Food Group (100%)

| | | | |
|---|---|---|---|
| 1. | Onion, fresh (equivalent to dry wt.) | 158 | grams |
| 2. | Olive oil | 280 | grams |
| 3. | Tomato, fresh (equivalent to dry wt.) | 14 | grams |
| 4. | Dry red pepper | 50 | grams |
| 5. | Garlic, fresh (equivalent to dry wt.) | 24 | grams |
| 6. | Celery, fresh (equivalent to dry wt.) | 16 | grams |
| 7. | Ginger, fresh (equivalent to dry wt.) | 6 | grams |
| 8. | Fenugreek | 0.5 | grams |
| 9. | Cardamom | 0.5 | grams |
| 10. | Salt | 2.0 | grams |

### Procedure

Onion and olive oil were transferred onto a heavy bottomed pan and heated on a stove set at medium heat. The components were mixed by stirring occasionally for about ten minutes. Tomato was then added and mixing continued for about five minutes. Water is added as needed. Dry ground red pepper was added and stirring continued for another ten minutes. The rest of the ingredients were finally added to the mixture while stirring. Stirring continued for about ten minutes to produce fresh sauce. The stove was turned off and the sauce allowed to cool to room temperature. The cooled sauce was then spread on trays, partially dehydrated at 65° C. to reduce the water content to 25-30% by weight, segmented, frozen at −20° C. and freeze dried. The segmented dried sauce was collected and packaged in moisture resistant bags or glass jars containing oxygen absorbers.

### Example 2: Segmented Dried Stew

### Formulation

Major Food Group (76.5%)

| | | | |
|---|---|---|---|
| 1. | Lentil | 900 | grams |

Accessory Food Group (23.5%)

| | | | |
|---|---|---|---|
| 2. | Onion, fresh (equivalent to dry wt.) | 79 | grams |
| 3. | Olive oil | 140 | grams |
| 4. | Tomato, fresh (equivalent to dry wt.) | 7 | grams |
| 5. | Dry red pepper | 25 | grams |
| 6. | Garlic, fresh (equivalent to dry wt.) | 12 | grams |
| 7. | Celery, fresh (equivalent to dry wt.) | 8 | grams |
| 8. | Ginger, fresh (equivalent to dry wt.) | 3 | grams |
| 9. | Fenugreek | 0.5 | grams |
| 10. | Cardamom | 0.5 | grams |
| 11. | Salt | 1.0 | gram |

### Procedure

The accessory food ingredients in Example 2 were first cooked to produce a fresh sauce according the procedure in Example 1. Then pre-cooked lentil was added to the fresh sauce and the mixture stirred occasionally for about ten minutes to prepare fresh lentil stew. The pan was removed from the stove. The lentil stew was spread on trays, cooled, partially dehydrated at 65° C. to reduce the water content to about 25-30% by weight, segmented, frozen at −20° C. and freeze dried. The segmented dried lentil stew was collected and packaged in moisture resistant bags or glass jars containing oxygen absorbers.

### Example 3: Segmented Dried Meal

### Formulation

Major Food Group (46.7%)

| | | | |
|---|---|---|---|
| 1. | Lentil | 600 | grams |

Accessory Food Group (14.4%)

| | | | |
|---|---|---|---|
| 2. | Onion, fresh (equivalent to dry wt.) | 52 | grams |
| 3. | Olive oil | 94 | grams |
| 4. | Tomato, fresh (equivalent to dry wt.) | 4 | grams |
| 5. | Dry red pepper | 16 | grams |
| 6. | Garlic, fresh (equivalent to dry wt.) | 8 | grams |
| 7. | Celery, fresh (equivalent to dry wt.) | 6 | grams |
| 8. | Ginger, fresh (equivalent to dry wt.) | 2 | grams |
| 9. | Fenugreek | 0.2 | grams |
| 10. | Cardamom | 0.2 | grams |
| 11. | Salt | 2.0 | grams |

Whole Grains (38.9%)

| | | | |
|---|---|---|---|
| 12. | Pre-cooked Teff (equivalent to dry wt.) | 500 | grams |

### Procedure

The accessory food ingredients and major food ingredient were cooked to produce fresh lentil stew according to the procedure in Example 2. Pre-cooked teff were then added to the fresh lentil stew while mixing occasionally for about ten minutes to prepare a fresh meal. The pan was then removed from the stove and the meal cooled to room temperature. The cooled meal was spread over trays, partially dehydrated at 65° C. to reduce the water content to about 25-30% by weight, segmented, frozen at −20° C. and freeze dried. The segmented dried teff meal was collected and packaged in moisture resistant bags or glass jars containing oxygen absorbers.

### Example 4: Powdered Dried Sauce

### Formulation

Accessory Food Group (100%)

| | | | |
|---|---|---|---|
| 11. | Onion, fresh (equivalent to dry wt.) | 158 | grams |
| 12. | Olive oil | 280 | grams |
| 13. | Tomato, fresh (equivalent to dry wt.) | 14 | grams |
| 14. | Dry red pepper | 50 | grams |
| 15. | Garlic, fresh (equivalent to dry wt.) | 24 | grams |
| 16. | Celery, fresh (equivalent to dry wt.) | 16 | grams |
| 17. | Ginger, fresh (equivalent to dry wt.) | 6 | grams |
| 18. | Fenugreek | 0.5 | grams |
| 19. | Cardamom | 0.5 | grams |
| 20. | Salt | 2.0 | grams |

### Procedure

Onion and olive oil were transferred onto a heavy bottomed pan and heated on a stove set at medium heat. The components were mixed by stirring occasionally for about ten minutes. Tomato was then added and mixing continued for about five minutes. Water is added as needed. Dry ground red pepper was added and stirring continued for another ten minutes. The rest of the ingredients were finally added to the mixture while stirring. Stirring continued for about ten minutes to produce fresh sauce. The stove was turned off and the sauce allowed to cool to room temperature. The cooled sauce was then spread on trays and freeze dried. The powdered dried sauce was collected and packaged in moisture resistant bags or glass jars containing oxygen absorbers.

### Example 5: Powdered Dried Stew

### Formulation

Major Food Group (76.5%)

| | | | |
|---|---|---|---|
| 12. | Lentil | 900 | grams |

Accessory Food Group (23.5%)

| | | | |
|---|---|---|---|
| 13. | Onion, fresh (equivalent to dry wt.) | 79 | grams |
| 14. | Olive oil | 140 | grams |
| 15. | Tomato, fresh (equivalent to dry wt.) | 7 | grams |
| 16. | Dry red pepper | 25 | grams |
| 17. | Garlic, fresh (equivalent to dry wt.) | 12 | grams |
| 18. | Celery, fresh (equivalent to dry wt.) | 8 | grams |
| 19. | Ginger, fresh (equivalent to dry wt.) | 3 | grams |
| 20. | Fenugreek | 0.5 | grams |
| 21. | Cardamom | 0.5 | grams |
| 22. | Salt | 1.0 | gram |

### Procedure

The accessory food ingredients in Example 5 were first cooked to produce a fresh sauce according the procedure in Example 4. Then pre-cooked lentil was added to the fresh sauce and the mixture stirred occasionally for about ten minutes to prepare fresh lentil stew. The pan was removed from the stove and the stew allowed to cool. The cooled stew was spread on trays, and freeze dried. The powdered dried lentil stew was collected and packaged in moisture resistant bags or glass jars containing oxygen absorbers.

### Example 6: Powdered Dried Meal

Formulation

Major Food Group (46.7%)

| | | | |
|---|---|---|---|
| 1. | Lentil | 600 | grams |

Accessory Food Group (14.4%)

| | | | |
|---|---|---|---|
| 2. | Onion, fresh (equivalent to dry wt.) | 52 | grams |
| 3. | Olive oil | 94 | grams |
| 4. | Tomato, fresh (equivalent to dry wt.) | 4 | grams |
| 5. | Dry red pepper | 16 | grams |
| 6. | Garlic, fresh (equivalent to dry wt.) | 8 | grams |
| 7. | Celery, fresh (equivalent to dry wt.) | 6 | grams |
| 8. | Ginger, fresh (equivalent to dry wt.) | 2 | grams |
| 9. | Fenugreek | 0.2 | grams |
| 10. | Cardamom | 0.2 | grams |
| 11. | Salt | 2.0 | grams |

Whole Grains (38.9%)

| | | | |
|---|---|---|---|
| 12. | Pre-cooked Teff (equivalent to dry wt.) | 500 | grams |

### Procedure

The accessory food ingredients and major food ingredient were cooked to produce fresh lentil stew according to the procedure in Example 5. Pre-cooked teff were then added to the fresh lentil stew while mixing occasionally for about ten minutes to prepare a fresh meal. The pan was then removed from the stove and the fresh meal cooled to room temperature. The cooled meal was spread over trays, and freeze dried. The powdered dried teff meal was collected and packaged in moisture resistant bags or glass jars containing oxygen absorbers.

What is claimed is:

1. A process for preparing Habesha dried food product, comprising the steps of:
(a) selecting ingredients from at least one of a major food group, an accessory food group, and a whole grain;
(b) cooking the selected ingredients in the style according to a Habesha cuisine to result in a fresh form of food, which is one of a sauce, a stew and a meal; and
(c) determining a final state as either a segmented dried form of food, or a powdered dried form of food,
wherein if the final state in step (c) is the segmented dried form of food, the process of preparing Habesha dried food product further comprises the steps of:
(d) partially dehydrating the fresh form of food in step (b) to 20%-30% of water by weight to result in a cake of food;
(e) cutting the cake of food on a tray to result in a segmented cake of food;
(f) freezing the segmented cake of food at −20° C. to result in a frozen segmented cake of food;
(g) freeze-drying the frozen segmented cake of food to result in the segmented dried form of food; and
(h) packaging the segmented dried form of food in a moisture-resistant bag, or in a glass jar containing an oxygen absorber to result in the Habesha dried food product,
wherein if the final state in step (c) is the powdered dried form of food, the process of preparing Habesha dried food further comprises the steps of:
(i) freeze-drying the fresh form of food in step (b) directly to result in the powdered dried form of food; and
(j) packaging the powdered dried form of food in a moisture-resistant bag, or in a glass jar containing an oxygen absorber to result in the Habesha dried food product,
wherein
the major food group is at least one member from the group consisting of a legume, a mushroom, a meat, and a fish,
the accessory food group is at least one member of the group consisting of a vegetable, a cooking oil, and a seasoning and flavoring, and
the whole grain is at least one member of the group consisting of quinoa, teff, corn, sorghum, buckwheat, brown rice, barley, oats, millet, barley and white wheat.

2. The process of claim 1, wherein the form of food is the sauce, and
the selecting ingredients from the accessory food group is 100% by weight.

3. The process of claim 1, wherein the form of food is the stew,
the selecting ingredients is from the major food group and the accessory food group in the following ratio by weight:
60-85% ingredients from the major food group, and
15-40% ingredients from the accessory food group.

4. The process of claim 1, wherein the form of food is the meal,
the selecting ingredients is from the major food group, the accessary food group, and the whole grain in the following ratio by weight:
30-55% ingredients from the major food group,
10-25% ingredients from the accessory food group, and
30-50% ingredients from the whole grain, wherein the whole grain is pre-cooked.

5. The process of claim 1, wherein the legume is least one of lentils, beans, peas, and chickpeas.

6. The process of claim 1, wherein the mushroom is least one of while button, portobello, cremini, maitake, button, hedgehog, morel and oyster.

7. The process of claim 1, wherein the meat is least one of beef, lamb, chicken, goat, and pork.

8. The process of claim 1, wherein the fish is least one of mackerel, tilapia, halibut, cod, trout, swordfish, salmon, and tuna.

9. The process of claim 1, wherein the vegetable is least one of onion, kale, spinach, cabbage, tomatoes, avocados, eggplants, cucumbers, and bell peppers.

10. The process of claim 1, wherein the cooking oil is at least one of olive oil, sunflower oil, soybean oil, safflower oil, corn oil, and canola oil.

11. The process of claim 1, wherein the seasoning and flavoring is at least one of basil, bay leaf, celery seed, chives, garlic, cilantro, fennel, fenugreek, lemon grass, oregano, parsley, rosemary, sage, tarragon, thyme, mint, cardamom, cinnamon, coriander, allspice, cloves, nutmeg, paprika, pepper, turmeric, ginger, mace, saffron, vanilla, cumin, black seed, dill seed, wine, and salt.

12. A process of serving Habesha food, comprising the steps of:
(a) adding sufficient water to the Habesha dried food product prepared according to the process of claim 1, to result in a water-reconstituted food, and
(b) heating the water-reconstituted food to result in the form of food to be served, wherein the form of food at least one of the sauce and the stew.
